(19) United States
(12) Patent Application Publication
(10) Pub. No.: US 2012/0288833 A1
(43) Pub. Date: Nov. 15, 2012

(54) System and Method for Language Instruction Using Multiple Prompts

(76) Inventors: Karl F. Ridgeway, Boulder, CO (US); Ronald Bryce Inouye, Harrisonburg, VA (US); Gregory Keim, Broadway, VA (US); Kyle D. Kuhn, Harrissonburg, VA (US); Jack August Marmorstein, Harrisonburg, VA (US); Robin Smith, Harrisonburg, VA (US); Brian Vaughn, Harrisonburg, VA (US)

(21) Appl. No.: 13/106,918

(22) Filed: May 13, 2011

(51) Int. Cl. G09B 19/04

(52) U.S. Cl. 434/156

(57) ABSTRACT

A method of teaching a language to a student by an instructor is disclosed, wherein the method may include the steps of the instructor uttering a first prompting phrase to the student; receiving a first response from the student in response to the first prompting phrase; modifying at least one characteristic of the first prompting phrase to generate a second prompting phrase; and the instructor uttering the second prompting phrase to the student, wherein at least one of the above steps is performed using a computer.

### BACKGROUND OF THE INVENTION

The present invention relates generally to teaching machines and, more particularly, concerns a system and method for teaching a language.

Traditional methods for teaching a language, in particular a foreign language, are far from enjoyable for students. Students spend a great deal of time learning rules of grammar and syntax and generally learn by memorizing words in the target language (the language being learned) that are translations of corresponding words in a source language. The only exposure to correct pronunciation might be on a recording or during discussions in a classroom. On such occasions, the student finds himself mentally composing his recitation in his native language and then translating it. The usual result is a halting, stilted recital, replete with grammatical and syntactic errors introduced by the translation process. The foregoing approach generally does not enable the language learner to converse fluently in the target language.

In contrast, upon first learning a language, young children are fully immersed in a natural learning process in which they learn words, grammar and syntax interactively through deductive reasoning, in context, and by emulating others. In time, children develop a flowing communication style, without the need to translate or to be concerned about rules. It would be desirable to be able to emulate this kind of learning process in learning a second language.

Systems of teaching a user language using immersion are known to some extent in the prior art. However, to best measure the user's progress, the language student should be prompted to speak naturally. Simply showing the user target language text to be read aloud is less than optimum, because read speech is not spoken the same way as natural speech not being read. Thus, attempting to gauge student progress by measuring an ability to read prepared text is generally not effective.

Accordingly, there is a need in the art for an improved system and method for language instruction that better emulates the immersion environment in which children typically learn their first language.

### SUMMARY OF THE INVENTION

According to one aspect, the invention is directed to a method of teaching a language to a student, wherein the method may include the steps of the instructor uttering a first prompting phrase to the student; receiving a first response from the student in response to the first prompting phrase; modifying at least one characteristic of the first prompting phrase to generate a second prompting phrase; and the instructor uttering the second prompting phrase to the student, wherein at least one of the above steps is performed using a computer.

The method is preferably used to assist students who already have a basic knowledge of a target language in becoming more fluent in that target language. In this regard, the modification of the at least one characteristic is preferably done in a phased and structured manner, with more and more modifications being possible as fluency or other measure of user progress warrants.

In a preferred aspect, a specific set of phrases is to be practiced by a student. Initially, a computer generated utterance is used to cause the student to respond with a phrase to be practiced. As the student progresses, the computer generated utterances used to cause the student to respond with a practice phrase may vary more and more, and the set of such computer generated utterances may also get larger. As a result, the student does not get used to responding to a sound with a particular response, losing the meaning and context. Instead, the student gradually is taught usage of, and fluency with, the response in a greater number of, and a greater diversity of, contexts.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a schematic block diagram of a language instruction system including a computer system and audio equipment suitable for practicing an embodiment of the present invention;

FIG. 2 is a flow diagram for a method of teaching a student to use a target phrase in accordance with an embodiment of the present invention;

FIG. 3 is a schematic illustration of an instructional conversation between an instructor and a student in accordance with an embodiment of the present invention;

FIG. 4 is a schematic illustration of an instructional conversation between an instructor and a student in accordance with an embodiment of the present invention;

FIG. 5 is a schematic illustration of an instructional conversation between an instructor and a student in accordance with an embodiment of the present invention;

FIG. 6 is a schematic illustration of an instructional conversation between an instructor and a student in accordance with an embodiment of the present invention;

FIG. 7 is a block diagram of a computer system useable in conjunction with one or more embodiments of the present invention;

FIG. 8 depicts a logic diagram of an exemplary embodiment of a system implementing the techniques of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” or “in an embodiment” in various places in the specification do not necessarily all refer to the same embodiment.

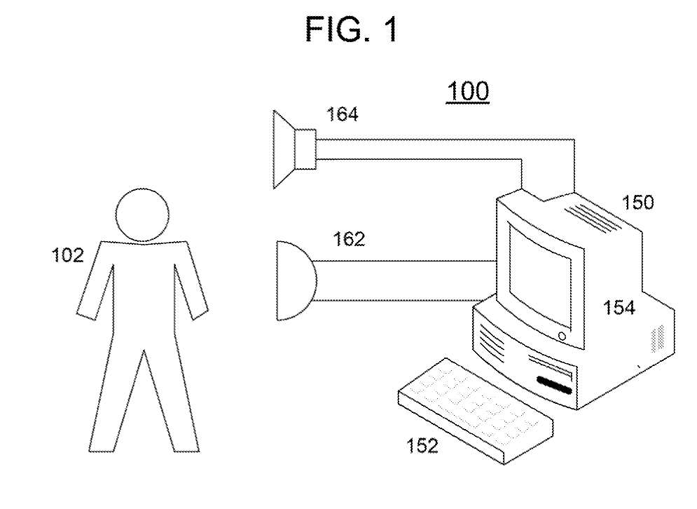

FIG. 1 is a schematic block diagram of a language instruction system 100 including a computer system 150 and audio equipment suitable for teaching a target language to student 102 in accordance with an embodiment of the present invention. Language instruction system 100 may interact with one language student 102, or with a plurality of students. Language instruction system 100 may include computer system 150, which may include keyboard 152 (which may have a mouse or other graphical user-input mechanism embedded therein) and/or display 154, microphone 162 and/or speaker 164. Language instruction system 100 may further include additional suitable equipment such as analog-to-digital converters and digital-to-analog converters to interface between the audible sounds received at microphone 162, and played from speaker 164, and the digital data indicative of sound stored and processed within computer system 150.

The computer 150 and audio equipment shown in FIG. 1 are intended to illustrate one way of implementing an embodiment of the present invention. Specifically, computer 150 (which may also referred to as “computer system 150”) and audio devices 162, 164 preferably enable two-way audio communication between the student 102 (which may be a single person) and the computer system 150. Computer 150 and display 154 enable visual displays to the student 102. If desired, a camera (not shown) may be provided and coupled to computer 150 to enable visual data to be transmitted from the student to the computer 150 to enable instruction 100 to obtain data on, and analyze, visual aspects of the conduct and/or speech of the student 102.

In one embodiment, software for enabling computer system 150 to interact with student 102 may be stored on volatile or non-volatile memory within computer 150. However, in other embodiments, software and/or data for enabling computer 150 may be accessed over a local area network (LAN) and/or a wide area network (WAN), such as the Internet. In some embodiments, a combination of the foregoing approaches may be employed. Moreover, embodiments of the present invention may be implemented using equipment other than that shown in FIG. 1. Computers embodied in various modern devices, both portable and fixed, may be employed including but not limited to Personal Digital Assistants (PDAs), cell phones, among other devices.

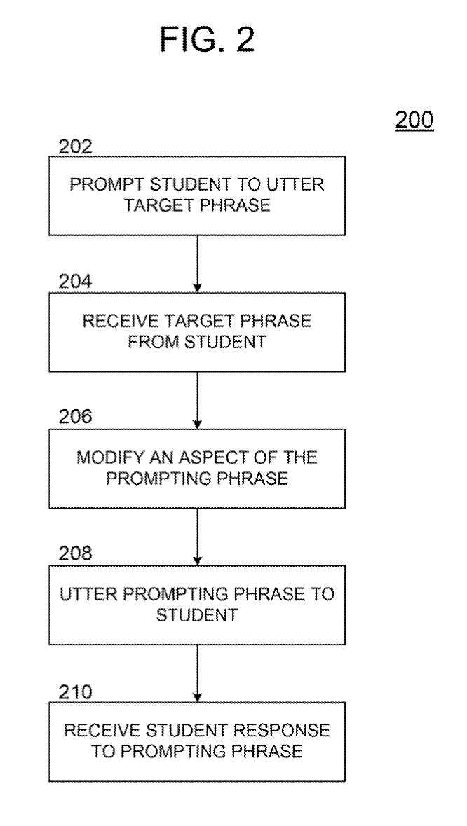

FIG. 2 is a flow diagram of a method 200 for language instruction to a student by an instructor, where the instructor may be one or more computing devices and/or one or more human beings. At step 202, the instructor (which may be system 100) may prompt the student 102 to utter a target phrase. The student then preferably utters the target phrase. At step 204, the instructor may receive, and in the case of a system-instructor 100, may optionally record the target phrase from the student.

At step 206, the instructor may modify an aspect of the prompting phrase, while still attempting to elicit the same target phrase from the student 102. Aspects of the prompting phrase which can be modified may include, but are not limited to: the wording of the prompting phrase, the location of the prompt within text uttered to the student, the accent with which the prompt is uttered, and/or various prosodic characteristics of the prompting phrase. The prosodic characteristics that may be modified include, but are not limited to: volume, pitch, the speed with which the prompt is spoken, the number of syllables in the prompt, the time lapse in between syllables, and/or the levels of emphasis employed for the respective syllables. Once the characteristics of the modified prompting phrase have been selected, the instructor preferably utters the modified prompting phrase to the student in step 208. In turn, the student preferably responds to the modified prompting phrase.

At step 210, the instructor receives the student response to the modified prompting phrase. System 100 may then evaluate the student response to determine whether it matches the target phrase. System 100 may update its database to evaluate the student's effectiveness in providing the same target phrase in response to a different prompt, thereby providing a score of sorts for the student. Additionally or alternatively, the system 100 may use the proximity of the student response to the target phrase to aid in evaluating the effectiveness of the algorithm for modifying the prompting phrase currently in use by the system 100. In the above manner, method 200 preferably causes the student 102 to think about the content of the prompting phrase and provide response that corresponds logically to the content of the prompting phrase, rather than merely provide a rehearsed response to a prompting phrase that the student 102 has memorized.

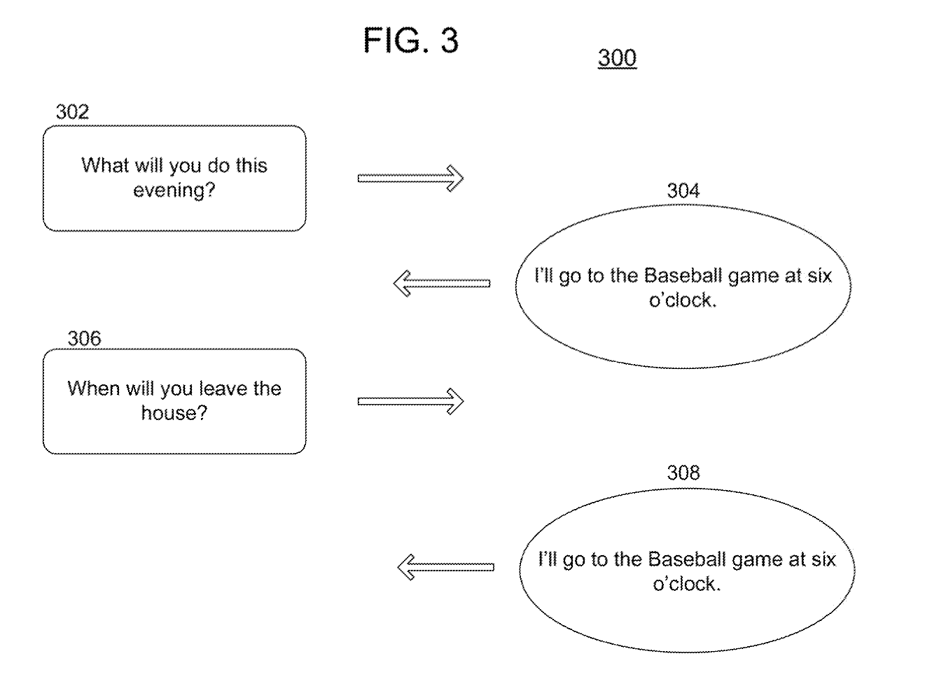

FIG. 3 is a schematic illustration of an instructional conversation 300 between an instructor and a student 102 in accordance with an embodiment of the present invention. The instructional conversation 300 shown in FIG. 3 illustrates one strategy for uttering two separate prompting phrases, in the form of queries, that both lead to the student 102 speaking the same target phrase in response. In the example below, the first query 302 asks “what” the student will do; and the second query 306 asks about “when” a particular event will occur. While queries asking “what” and “when” are useful for illustrating the variation in the language for eliciting a particular target response in the embodiment of FIG. 3, it will be appreciated that numerous other variations in the prompting phrases 302 and 306 may be practiced without departing from the scope of the present invention. Specifically, other types of “journalistic” type queries may be employed to cause the student 102 to conform his/her reply to the content of the prompt. Specifically, the nature of the query may include asking “where” an event occurs, the identity of persons involved in an activity (i.e. the “who/whom” question), the time at which an event will occur (the “when” question), “how” an event or activity will occur, and why the student is undertaking a particular activity.

Turning to FIG. 3, in statement 302, the instructor (either human or machine) asks the student “What will you do this evening?” In statement 304, the student 102 replies “I'll to go the Baseball game at six o'clock.” Taking another tack, the instructor, in statement 306, asks “when will you leave the house?” In response, in statement 308, the student replies “I'll go to the Baseball game at six o'clock.” It is noted that although FIG. 3 only shows the instructor asking two questions for the sake of brevity, it will be appreciated that any number of questions could be asked of the student to elicit a particular target phrase in response thereto.

In the conversation depicted in FIG. 3, having received a first reply, the instructor shifts the form of the question from asking “what” the student will do to asking “when” the student will perform a subsidiary task, as outlined below. In this manner, the series of questions is operable to ensure that the student understands the logic of the reply in relation to a range of possible questions rather than merely relying upon rote memorization of a series of known replies to series of respective questions.

This inventive procedure of slight variations in the prompting phrase or question causes the user to practice the same or substantially similar response to increase fluency, and use of the various terms.

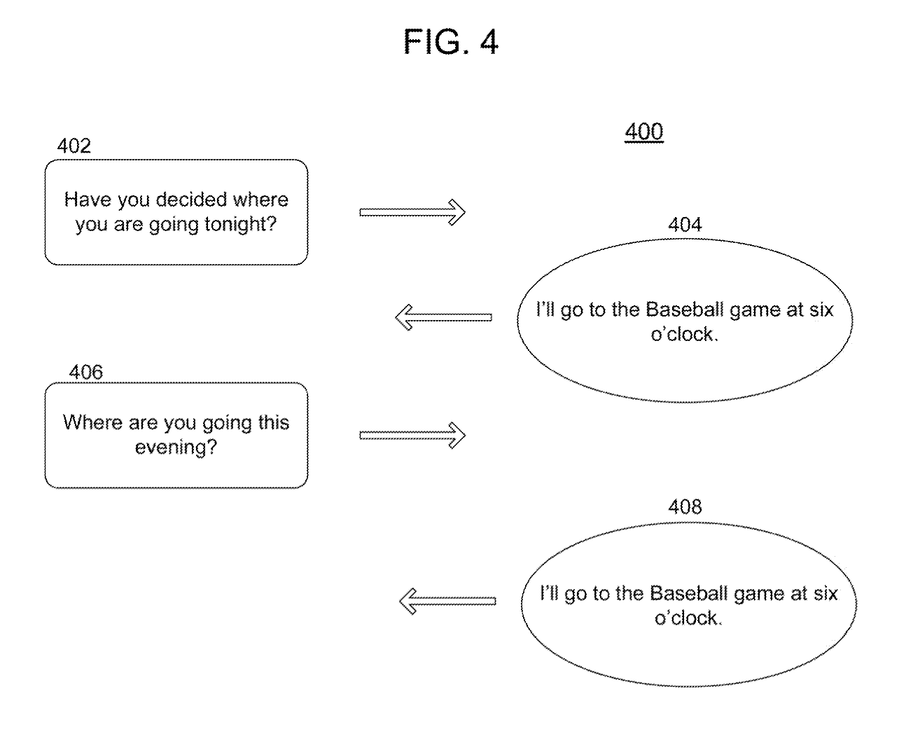

FIG. 4 is a schematic illustration of an instructional conversation using variation in the wording of a query phrase to elicit a common target response phrase in accordance with an embodiment of the present invention. In statement 402, the instructor asks the student “Have you decided where you are going tonight” to which the student replies, in statement 404, “I'll go to the Baseball game at six o'clock”. In statement 406, the instructor asks the student 102 “Where are you going this evening?”. In statement 408, the student replies with the same target phrase “I'll go to the Baseball game at six o'clock”. Employing this approach, the student 102 is therefore less likely to provide a memorized, rehearsed response by memorizing a standard response to the specific phrasing of a particular question. By having the student instead answer a succession of questions having similar meanings, but with variations in wording, the student is induced to logically associate the response with the meaning of the question, rather than answering using rote memorization.

The auditory attributes of the prompting phrase used by the instructor may be varied in place of, or in addition to, variation of the wording of the prompting phrase. More specifically, the auditory attributes that could be changed may include the accent the instructor speaks with. Other auditory attributes of the prompting phrase that can be modified may include the pitch, the volume, the rhythm, the number of syllables, the degree of emphasis employed for the various syllables, and/or the speed with which the prompting phrase is uttered by the instructor.

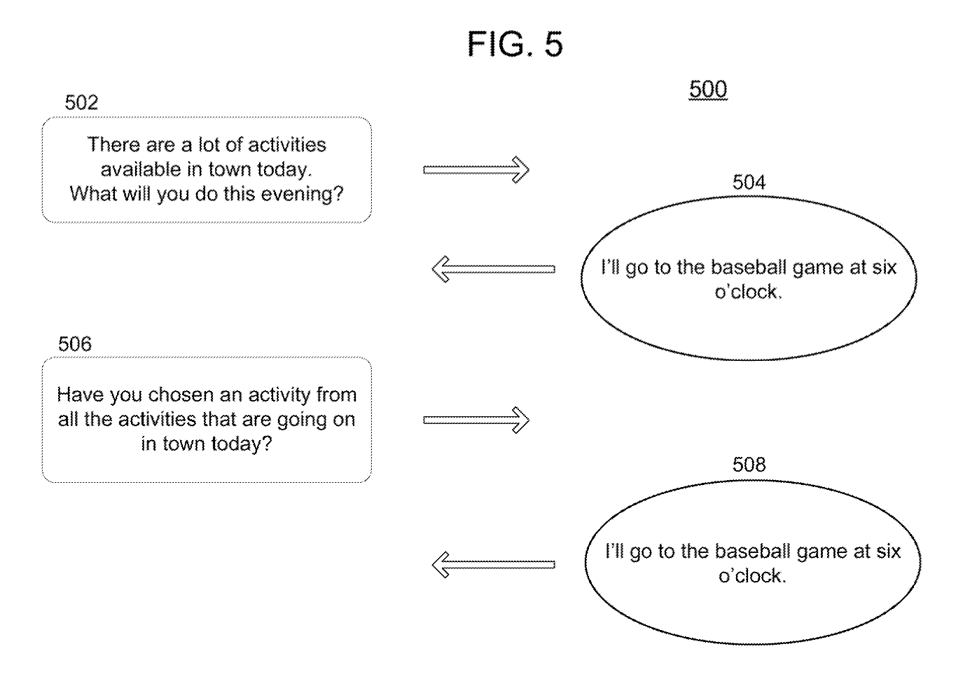

FIG. 5 is a schematic illustration of an instructional conversation 500 between an instructor and a student in accordance with an embodiment of the present invention. In the conversation depicted in FIG. 5, the instructor changes the location of the query within the prompting phrase in proceeding from statement 502 to statement 506, thereby requiring the student 102 to understand the meaning of, and the phrasing, of the question rather than responding to a fixed sequence of words in the initial prompting phrase 502 with a known, memorized reply.

In statement 502, the instructor recites “There are a lot of activities available in town today. What will you do this evening?” In statement 504, the student 102 responds with “I'll go to the Baseball game at six o'clock”. It is noted that in statement 502 an affirmative statement appears first, followed by a question related to the statement. In statement 506, the question has been changed so as to be the first and only sentence in the instructor's prompting phrase 506. Specifically, the instructor asks “Have you chosen an activity from all the activities that are going on in town today?” The student 102 responds with “I'll go to the baseball game at six o'clock”. Asking questions in the above manner preferably encourages the student 102 to heed the meaning and content of the question wherever the question is located within the query text in order to answer meaningfully.

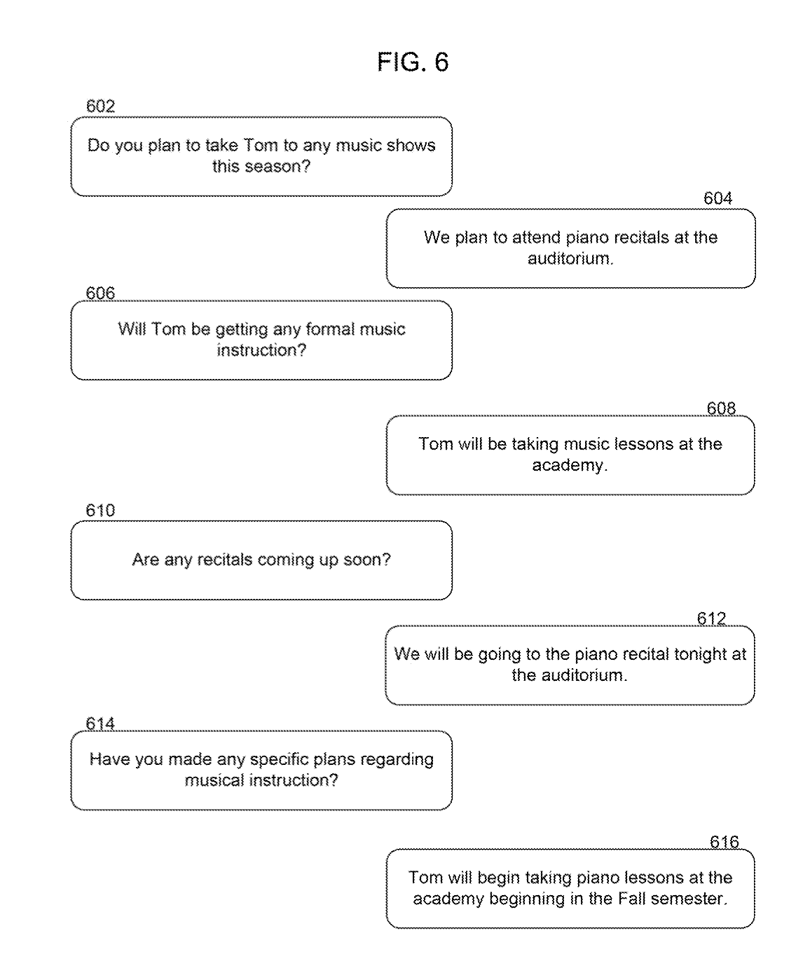

FIG. 6 is a schematic illustration of an instructional conversation between an instructor and a student 102 including two interleaved conversations, in accordance with an embodiment of the present invention. In the following, and in FIG. 6, two separate question-and-answer session are embedded within two respective conversations that are interleaved within a single sequence of answers and replies. In this manner, to answer meaningfully, the student 102 needs to respond to the content of the most recent query as opposed to resorting to rote memorization of a correspondence between known questions and known answers.

In statement 602, the instructor begins the first of two interleaved conversations, by asking the student 102 “Do you plan to take Tom to any music shows this season?” The answer of student 102 to this first query of the first conversation is “We plan to attend piano recitals at the auditorium” (statement 604). In the first query of the second conversation, in statement 606, the instructor asks student 102 “Will Tom be getting any formal music instruction?” In reply in statement 608, student 102 says “Tom will be taking music lessons at the academy.”

A second question, in statement 610, within the first conversation picks up the first conversation where statement 604 left off, in which the instructor asks student 102 “Are any recitals coming up soon?” In statement 612, the student 102 replies “We will be going to the piano recital tonight at the auditorium.” In statement 614, the instructor picks up the second conversation where statement 608 left off, asking “Have you made any specific plans regarding musical instruction?” In statement 616, the student 102 replies “Tom will begin taking piano lessons at the academy beginning in the Fall semester.”

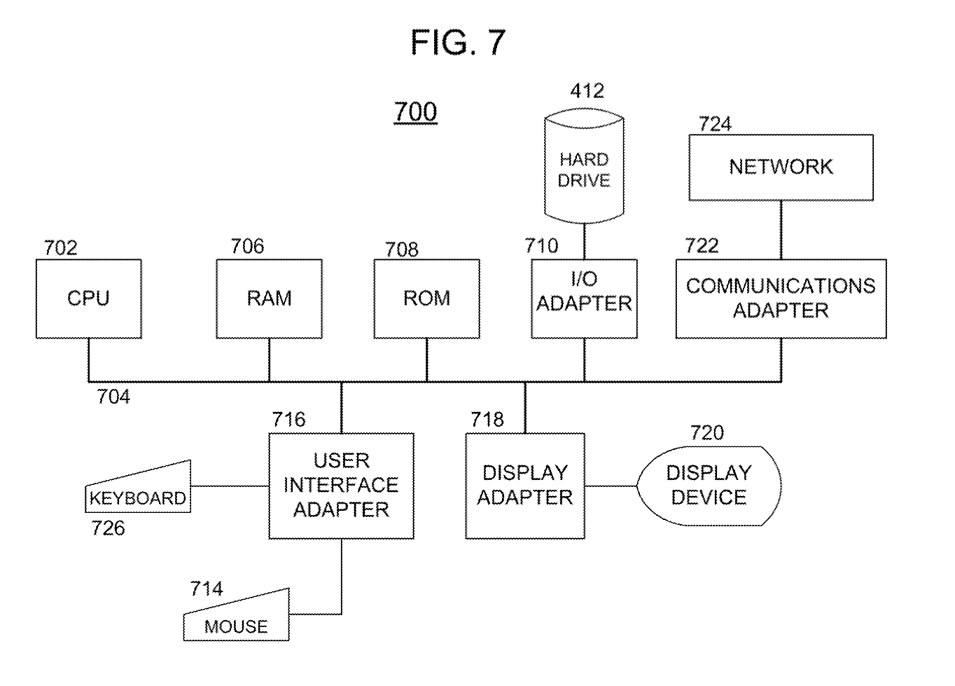

FIG. 7 is a block diagram of a computing system 700 adaptable for use with one or more embodiments of the present invention. Computer system 700 may generally correspond to computer system 150 of FIG. 1. Central processing unit (CPU) 702 may be coupled to bus 704. In addition, bus 704 may be coupled to random access memory (RAM) 706, read only memory (ROM) 708, input/output (I/O) adapter 710, communications adapter 722, user interface adapter 706, and display adapter 718.

In an embodiment, RAM 706 and/or ROM 708 may hold user data, system data, and/or programs. I/O adapter 710 may connect storage devices, such as hard drive 712, a CD-ROM (not shown), or other mass storage device to computing system 600. Communications adapter 722 may couple computing system 700 to a local, wide-area, or global network 724. User interface adapter 716 may couple user input devices, such as keyboard 726, scanner 728 and/or pointing device 714, to computing system 700. Moreover, display adapter 718 may be driven by CPU 702 to control the display on display device 720. CPU 702 may be any general purpose CPU.

In one preferred embodiment, the permissible computer generated utterances that induce the target response vary more greatly with continued use of the system. That is, initially, there is a single permissible computer generated utterance that causes the target response or a substantially similar target response. As use of the system by the student progresses, or as progress is otherwise measured, an additional one or more permissible computer generated utterances which invoke a similar target response are introduced.

At first, these one or more additional permissible computer generated utterances vary from the first computer generated utterance only slightly. One example is where the additional computer generated utterances may have the same meaning and may only vary in syntax slightly. The first one is “What time does the movie start?” and the additional permissible one may be “What is the start time for the movie?”, or “Do you know what time the movie starts?” All of these phrases have substantially the same meaning, but vary slightly in syntax and structure. This variation assists the user in thinking about the meaning of the phrases prior to answering. However, each of the latter two phrases only varies slightly from the original phrase, and all have substantially the same meaning. Yet, once the two additional permissible variations are introduced, whenever the system is to invoke the desired response—“six o'clock” the computer generated utterance that causes the user response is chosen from one of the three.

As the student becomes more fluent and progresses, and additional computer generated utterance may be introduced. Staying with the above example, another permissible computer generated utterance may now be introduced, this one varying even more from the first one by having a different meaning. For example, another set of such utterances may be “What time is the appointment with the real estate broker?” and “What time will we meet with the real estate broker?” With these additional permissible computer generated utterances, the user may get any of six different utterances intended to cause the “6 o'clock” response, wherein the first three have completely different meanings from the second three.

As other variations are introduced, the difference between the original permissible computer generated utterance, and the additional permissible ones, may get greater. Regardless however, as use of the system progresses, there are a larger number of utterances that are intended to elicit a substantially similar phrase. Hence, the user if forced to practice that phrase in the context in which it is used, causing greater understanding and fluency.

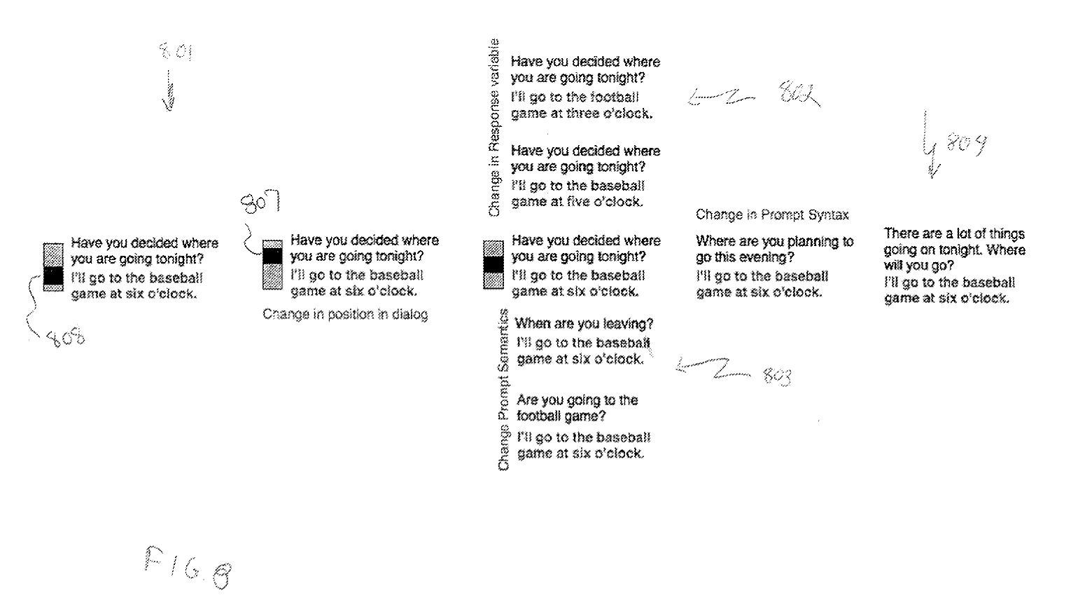

FIG. 8 represents the logic of an exemplary embodiment of the present invention. Each of the four directions in FIG. 8 represents a type of variation that can be implemented in an audio stream being used to train a user in a target language.

Direction 801 represents changing of the same dialog to a different place in the audio stream, as indicated by the dialog being located at 808 or 807 as shown. By altering the position of the same specific audio, the goal of a user not giving an automatic response without understanding the context is avoided, as the user must increase his concentration and understanding of the specific audio because it could may appear at random places throughout a training dialog.

The rightward direction 804 represents the inventive system prompting a user to practice the audio at issue by altering the prompting syntax. That is, the user can not automatically respond to a sound because the sound that prompts the phrase to be practiced will vary, as shown at 804. Similarly, the direction 803 will also vary prompting semantics to ensure the user is gaining understanding of the phrase before he responds. Further, direction 802 allows a change in response variables, based upon images or text displayed, for example.

The diagonal directions, 820 and 810, represent further possible variations in the audio interaction. Specifically, direction 820 shows the role of the same speaker changing, although the speaker himself may remain the same. The lower right direction 810 depicts a change in the speaker.

Generally, there are multiple dimensions in which the system may vary, and the type and extent of variation may optionally be based upon a user's progress, as measured by his pronunciation, speed, other parameters, or a combination of both. Additionally, the type of variation may be selected randomly, with the amount of variation being dependent upon progress of the user.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. One or more embodiments of the invention may also be embodied in a software program for storage in a suitable storage medium and execution by a processing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of teaching a language to a student by an instructor, the method comprising the steps of:
the instructor uttering a first prompting phrase to the student;
receiving a first response from the student in response to the first prompting phrase;
modifying at least one characteristic of the first prompting phrase to generate a second prompting phrase; and
the instructor uttering the second prompting phrase to the student, wherein at least one of the above steps is performed using a computer, and wherein, the modifying of said at least one characteristic is accomplished such that a substantially similar response to the first response is elicited, and wherein said modification to elicit said substantially similar response varies more as progress of said user increases.

2. The method of claim 1 wherein the step of modifying the prompting phrase is prevented if progress of said student is below a threshold.

3. The method of claim 1 wherein the characteristic is selected from the group consisting of:
vocabulary used in the prompting phrase; location of the prompt within text uttered to the student; accent with which the prompt is uttered; grammatical format of the prompting phrase, role or identity of speaker.

4. The method of claim 1 wherein the modifying step comprises modifying at least one prosodic characteristic of the prompting phrase, wherein the at least one prosodic characteristic is selected from the group consisting of: volume; pitch; the number of syllables in the prompting phrase; the lapse in time between successive syllables in the prompting phrase; the speed with which the prompting phrase is uttered; and the levels of emphasis applied to the respective syllables of the prompting phrase.

5. The method of claim 1 wherein the step of uttering the first prompting phrase comprises:
(a) asking the student about one of the time, location, and content of a planned activity;
and wherein the step of modifying comprises:
(b) modifying the prompting step so as to ask about another one of the time, location, and content of a planned activity than asked about in step (a).

6. The method of claim 1 wherein the modifying step comprises:
changing the order of words in the first prompting phrase while querying for substantially the same information, to generate the second prompting phrase.

7. The method of claim 1 wherein the modifying step comprises:
changing the number of sentences in the first prompting phrase to provide the second prompting phrase.

8. The method of claim 1 further comprising:
where the prompting, receiving, modifying, and uttering steps form an initial conversation,
initiating an additional conversation with the student with an additional first prompting phrase; and
interleaving the initial conversation with the additional conversation.

9. The method of claim 1 further comprising:
the instructor receiving a second response from the student.

10. The method of claim 9 further comprising:
the instructor determining an extent of disparity between the first student response and the second student response.

11. The method of claim 10 further comprising:
the instructor grading the student based on the extent of the disparity.

12. A language instruction system, including a computer, for teaching a language to a student, wherein the instruction system is operable to:
utter a first prompting phrase to the student;
receive a first response from the student in response to the first prompting phrase;
modify at least one characteristic of the first prompting phrase to generate a second prompting phrase; and
utter the second prompting phrase to the student.

13. The system of claim 12 wherein the step of modifying the prompting phrase is conducted so as to induce the student to utter the same phrase in response to the second prompting phrase as uttered in response to the first prompting phrase.

14. The system of claim 12 wherein the characteristic is selected from the group consisting of:
vocabulary used in the prompting phrase; location of the prompt within text uttered to the student; accent with which the prompt is uttered; grammatical format of the prompting phrase.

15. The system of claim 12 wherein the modifying step comprises modifying at least one prosodic characteristic of the prompting phrase, wherein the at least one prosodic characteristic is selected from the group consisting of: volume; pitch; the number of syllables in the prompting phrase; the lapse in time between successive syllables in the prompting phrase; the speed with which the prompting phrase is uttered; and the levels of emphasis applied to the respective syllables of the prompting phrase.

16. The method of claim 12 wherein the modifying step comprises:
changing the order of words in the first prompting phrase while querying for substantially the same information, to generate the second prompting phrase.

17. The system of claim 12 wherein the prompting, receiving, modifying, and uttering steps form an initial conversation, and wherein the system is further operable to:
initiate an additional conversation with the student with an additional first prompting phrase; and
interleave the initial conversation with the additional conversation.

18. The system of claim 12 wherein the system is further operable to:
receive a second response from the student.

19. The system of claim 18 wherein the system is further operable to:
determine an extent of disparity between the first student response and the second student response.

20. The method of claim 19 wherein the system is further operable to:
grade the student based on the extent of the disparity.

21. A method of inducing a student to practice a target phrase in a target language, said method comprising:
inducing recitation of the target phrase by a first computer generated utterance,
repeatedly inducing recitation of the target phrase or a substantially similar target phrase by one or more other permissible computer generated utterances,
wherein the number of other permissible computer generated utterances increases as a function of said student's practice.

22. The method of claim 21 wherein the variation among said other permissible computer generated utterances increases as a function of said student's progress.

23. The method of claim 21 wherein there are a plurality of target phrases invoked by a plurality of first computer generated utterances.

24. A method comprising, using an inducement phrase to induce a response in a target language, measuring the progress of pronunciation in the target language of the induced phrase, and varying the position of the induced phrase in a dialog, or the inducement phrase, to a degree that increases as said measured progress increases.

25. The method of claim 24 further comprising varying inducement phrase, as said measured progress increases, such that a predetermined portion of the response in the target language varies but the remaining portion of the response in the target language does not vary.

26. The method of claim 24 further comprising varying either the role or identity of a non-player character uttering the inducement phrase.

27. The method of claim 26 wherein the role or the identity of the non-player is varied in response to measured user progress.

28. A method comprising pre-establishing plural dimensions of variation in an inducement phrase, measuring a user's progress in responding to said inducement phrase with an induced response, selecting at least one of said plural dimensions in which to vary said inducement phrase, varying said inducement phrase in said selected dimension by an amount dependent upon said measured user progress, wherein said one of said plural dimensions in which said inducement phrase varies is selected randomly.
